(19) United States
(12) Patent Application Publication
(10) Pub. No.: US 2005/0173605 A1
(43) Pub. Date: Aug. 11, 2005

(54) Display shelving device with integrated electrical power supply means for lighting units

(75) Inventors: Daniel Villeneuve, Senlis (FR); Patrick Carlin, Biot (FR); Philippe Luguet, Orgeval (FR)

Correspondence Address: OLIFF & BERRIDGE, PLC, P.O. BOX 19928, ALEXANDRIA, VA, 22320, US

(73) Assignee: WATTOHM TECHNOLOGIES, Senlis (FR)

(21) Appl. No.: 11/029,462

(22) Filed: Jan. 6, 2005

(30) Foreign Application Priority Data
Jan. 20, 2004 (FR) 04.00486

(51) Int. Cl. F21S 8/00; F21V 29/00

(52) U.S. Cl. 248/301; 362/147

(57) ABSTRACT

This display shelving device is formed from a panel with multiple interlocking metal strip sections installed and fixed against a plane wall or special supporting structures, and comprising longitudinal recesses in the strip sections and/or at the junction of these sections. Slats made of insulating synthetic material are mounted in the recesses of the strip sections and include longitudinal slots within which power supply electrical conductors run longitudinally. The latter supply lighting units by means of detachable adaptors retained in the recesses, and of electrical links with the lighting units. Support brackets are mounted in the recesses in order to support detachable trays on the underside of which are fixed the lighting units. Application: presentation of articles (A) with lighting on retail or display premises.

### BACKGROUND OF THE INVENTION

The present invention relates to a display shelving device, of the sort formed by multiple interlocking strip sections, these sections being capable of being installed and fixed against a wall, another plane wall, or against special support structures, the longitudinal edges of two consecutive strip sections locking into one another, and longitudinal recesses, capable of receiving accessories, being formed in the strip sections or at the junctions of these sections. Such a device is more particularly designed for the presentation of articles on retail or display premises.

When a display shelving device of this type requires lighting, the electrical power supplies are usually provided by means of power sockets embedded in the middle of a specific, specially designed, strip section. This complicates the structure of the device by interrupting the continuity of the channeling forming the strip sections. Above all, such means of supplying electrical power are positioned in a localized and invariable manner, and do not allow the availability of the option of electrical connection at any given point with an unlimited number of positions, chosen freely and which can be modified when needed.

Furthermore, there exist “rails” that allow accessories, such as spotlights, to be mounted and to be supplied with electricity, the whole of which, including the mounting, is specially designed to adapt to the profile of the rail. Systems called “electrostrips” are also known that allow power sockets to be positioned on an electrical supply strip. These existing systems permit mounting or power supply points for electrical accessories to be freely chosen, but they do not, in themselves, constitute display shelving devices, and do not allow standard accessories to be mounted and supplied with electricity without special adaptation.

### DESCRIPTION OF THE PRIOR ART

In U.S. Pat. No. 4,747,025, a display full panel is described that is formed from a single piece, in which parallel recesses are opened up that allow electrical lighting means, powered by low voltage from a step-down transformer, to be mounted. The mechanical attachment and electrical supply of each lamp is effected between two consecutive recesses of the panel, longitudinal electrical conductors being disposed externally, on the surface of the panel, along the edges of the recesses.

In such a known system, the power supply electrical conductors are therefore directly accessible and are not protected, which prohibits the system being used with normal mains voltages (i.e. 220 volts in France). Thus, the use of this system is limited to specific lighting units operating at low voltage. On the other hand, the system of U.S. Pat. No. 4,747,025 is not at all adapted to the electrical supply of lamps operating at normal voltage. Moreover, this document does not describe any means allowing articles of various kinds to be put on display.

Most of these drawbacks have been solved by patent FR 2 720 247 that describes a presentation or display device, of the type described above, in whose longitudinal recesses power supply electrical conductors run longitudinally, and into which recesses detachable modules can be introduced and retained for the mounting of lighting units.

This known presentation or display device for commercial lighting units satisfies the safety standards by a suitable protection of the electrical conductors, and allows a wide choice of position for the lighting units, but it is only satisfactory when the lighting units themselves constitute the articles on display. For the display of other types of articles, for which it is desired to enhance the commercial appeal, this device does not allow any desired kind of lighting arrangement, in particular a “front” lighting system, to be used.

### SUMMARY OF THE INVENTION

The present invention aims to provide a display shelving device with multiple interlocking strip sections that allows any lighting arrangement designed to highlight articles presented, in particular a “front” lighting system, to be implemented with lighting unit electrical supply means that allow a free choice of the position of the lighting units while providing an extreme ease of use and a satisfactory degree of safety by ensuring a suitable protection of the electrical conductors.

For this purpose, the subject of the invention is a display shelving device, in particular for the presentation of articles on retail or display premises, of the sort formed by multiple interlocking strip sections, these sections being capable of being installed and fixed against a wall or another plane surface, or else against supports such as uprights designed for this purpose, the longitudinal edges of two consecutive strip sections locking into one another, and longitudinal recesses, in which power supply electrical conductors for the supply of lighting units run longitudinally, being formed on the strip sections and/or at the junction of these sections, support mechanisms being mounted in said longitudinal recesses in order to support detachable trays, onto the underside of which are fixed the lighting units.

Accordingly, the inventive idea consists in mounting tray support mechanisms, of the bracket type, in the longitudinal recesses formed in the strip sections and/or at the junction of these sections, such that the lighting can be shifted to any position underneath the trays in order to highlight an article disposed on a lower tray. Moreover, the retention of the support mechanisms and the electrical supply of the lighting unite can be provided in a single and same longitudinal recess. Aside from its esthetic appeal of being discreet, this arrangement ia particularly desirable for equipping retail stores and display premises, since it provides an enhanced ease of use and a greater freedom in the choice of position for the trays. The device obtained is therefore completely modular as regards both the shelf positioning and the lighting.

Advantageously, the power supply electrical conductors supply the lighting units by means of detachable adaptors capable of being introduced and retained in the longitudinal recesses of the strip sections, and of electrical links with the lighting units.

This allows the lighting unit to be “suspended” at any position on the tray, even well away from the panel formed by the interlocking sections, for example in order to implement a “front” lighting of the articles to be presented. Each adaptor, of a type known per se, cooperates with the electrical conductors integrated into the strip sections, and is connected to the lighting unit by electrical links such as simple wires. The displacement of an adaptor from one position to another can be easily and rapidly carried out. The adaptor can supply any type of lighting unit (lamp, spotlight, fluorescent tube, etc.).

According to a preferred embodiment of the invention, the strip sections are produced in the form of metal channel sections, insulating slats in the form of profiled slats made of synthetic material being mounted within the longitudinal recesses formed in the strip sections and/or at the junction of the strip sections, said insulating slats themselves having longitudinal slots in which the lighting unit power supply electrical conductors are lodged.

Once assembled, the strip sections. for example made of aluminum, form a supporting panel, while the slats ensure the electrical isolation of the power supply electrical conductors.

The latter run longitudinally along the whole length of the slats. Thus hidden within the slots of the slats, they constitute a discreet electrical supply system which does not affect the esthetic appearance of the device.

### DESCRIPTION OF THE DRAWINGS

In any case, the invention will be better understood by means of the description that follows, where reference is made to the appended schematic drawing showing an exemplary embodiment of this display shelving device, in which:

FIG. 1 is a cross-sectional view of a display shelving device according to the present invention;

FIG. 2 is a partial cross-sectional view of the same device, illustrating the mounting of an adaptor.

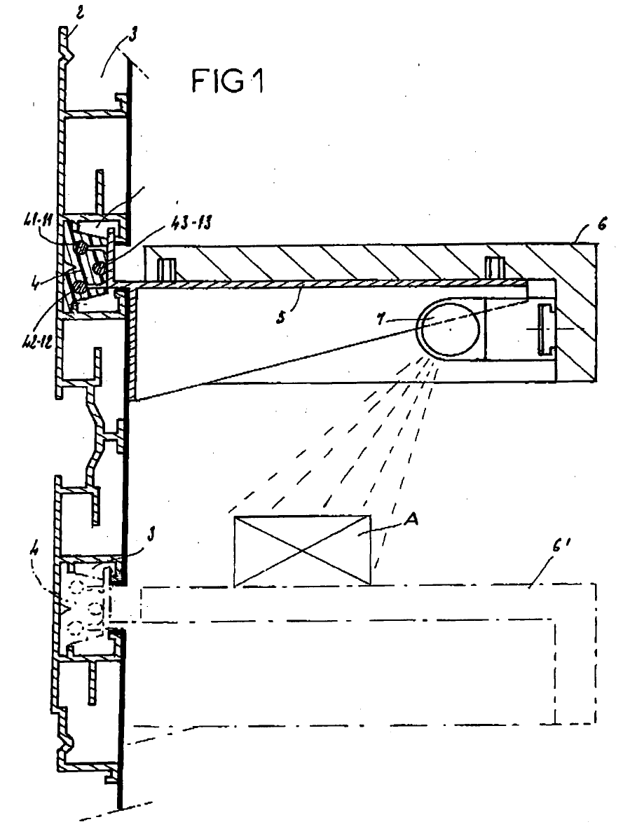

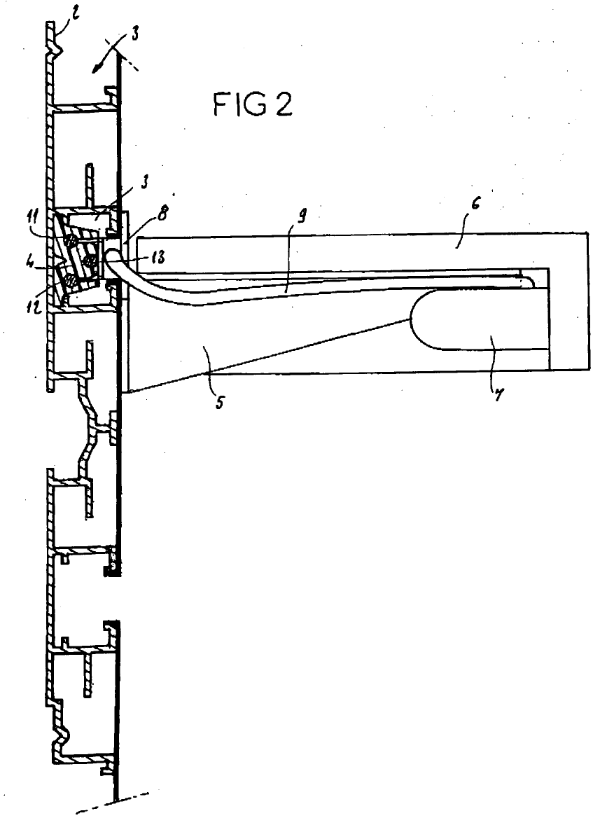

As illustrated in FIGS. 1 and 2, longitudinal recesses 3 having, advantageously, a “T” cross-sectional profile are formed in aluminum strip sections 2 that, once locked together, form a supporting panel. These recesses 3 receive insulating slats 4 made of insulating synthetic material.

Three longitudinal slots 41, 42, 43 with a suitable profile are formed within each slat 4; they each constitute a housing for a power supply electrical conductor produced in the form of a metal wire; a neutral conductor 11, a phase conductor 12 and a ground conductor 13.

The three slots 41, 42, 43 are open towards the inside of the recess 3 such that the corresponding electrical conductors 11, 12, 13 all have an open area that can locally make contact with other electrically conducting elements.

The neutral conductor 11 and phase conductor 12 are well embedded into the slat 4 such that only a suitable-designed conducting element can make contact with them, thus providing enhanced safety.

The recesses 3 receive support brackets 5 on which sit the detachable. trays 6 so as to form shelves.

It will be noted that the ground conductor 13 is slightly protruding, in order to facilitate its contact with any metallic object that might be introduced into the recess, in particular a support bracket 5 for the detachable tray 6. Naturally, this ground conductor 13 further enhances the device safety.

A fluorescent tube lamp 7 is fixed using known means underneath each tray 6, at any position appropriate for lighting an article A displayed on a lower tray 6′: the choice of the position for the lamp 7 is totally free, especially since the trays 6 are movable and do not comprise any electrical connection, a fact which allows their configuration to be varied without modification to the supporting panel and without special tools. A “front” lighting arrangement can therefore be implemented for an article A disposed on a tray 6′ at a lower shelf.

As illustrated in FIG. 2, for the supply of the lamp, a detachable electrical adaptor 8, of a type known per se, is engaged in a recess 3 and is pushed by its electrical contacts against the respective electrical conductors 11, 12 incorporated into the slat 4 of the recess 3.

The phase and neutral contacts of the adaptor 8 are connected by conventional electrical links 9 to a lamp 7 fixed underneath the tray 6. They can be completed by a ground contact with corresponding electrical link.

The adaptor 8 can supply any type of lighting unit (lamp, tube, spotlight, etc.); it can be removed then replaced in the same recesses 3 at any location, each new location thus chosen still providing the electrical supply in the same manner.

The general electrical supply of the device must, of course, bring the electrical current to the conductors 11, 12, 13 inserted into the various recesses 3. This general power supply is implemented either on the front face via a dedicated module designed for this purpose, or by a specific lateral element situated at one end of the strip sections 2.

### DESCRIPTION OF THE PREFERRED EMBODIMENTS

The device described above can, in particular, be used for equipping retail stores and display premises.

The scope of the invention, as defined in the appended claims, would still be respected by, notably;
producing the trays and their support brackets as a single piece;
using any kind of lighting unit such as a lamp, tube or bulb in any configuration and in any number.

1. A display shelving device, in particular for the presentation of articles on retail or display premises, of the sort formed by multiple interlocking strip sections, these sections being capable of being installed and fixed against a wall or another plane surface, or else against supports such as uprights designed for the purpose, the longitudinal edges of two consecutive strip sections locking into one another, and longitudinal recesses, in which power supply electrical conductors for the supply of lighting units run longitudinally, being formed on the strip sections and/or at the junctions of these sections, wherein support mechanisms are mounted in said longitudinal recesses in order to support detachable trays, onto the underside of which are fixed the lighting units.

2. The display shelving device as claimed in claim 1, wherein the power supply electrical conductors supply the lighting units by means of detachable adaptors, capable of being introduced and retained in the longitudinal recesses of the strip sections, and of electrical links with the lighting units.

3. The display shelving device as claimed in claim 1, wherein the strip sections are produced in the form of metal channel sections, insulating slats in the form of profiled slats made of synthetic material being mounted within the longitudinal recesses formed in the strip sections and/or at the junction of the strip sections, said insulating slats themselves having longitudinal slots in which the power supply electrical conductors are lodged.

4. The display shelving device as claimed in claim 2, wherein the strip sections are produced in the form of metal channel sections, insulating slats in the form of profiled slats made of synthetic material being mounted within the longitudinal recesses formed in the strip sections and/or at the junction of the strip sections, said insulating slats themselves having longitudinal slots in which the power supply electrical conductors are lodged.
